(19) United States
(12) Patent Application Publication
(10) Pub. No.: US 2025/0391906 A1
(43) Pub. Date: Dec. 25, 2025

(54) SEALABLE FIXTURE FOR HIGH-PRESSURE COMPRESSION OF SOLID-STATE ELECTROCHEMICAL CELLS OR COMPONENTS THEREOF

(71) Applicant: Solid Power Operating, Inc., Louisville, CO (US)

(72) Inventor: David A. TELEP, Longmont, CO (US)

(21) Appl. No.: 19/244,765

(22) Filed: Jun. 20, 2025

Related U.S. Application Data
(60) Provisional application No. 63/662,832, filed on Jun. 21, 2024.

(51) Int. Cl. H01M 10/04

(52) U.S. Cl. CPC H01M 10/0481

(57) ABSTRACT

Systems and methods for producing a solid-state battery cell using an isostatic press to apply a substantially uniaxial load on the flat surfaces of the cell. In some arrangements, a cell housing, configured for the size and thickness of cells to be processed, is provided. The housing may have a shape and depth such that individual battery cells or some portion thereof may lie within the housing. The housing may include features, such as a top plate and a bottom plate, between which an electrochemical cell may be located for isostatic pressing of the electrochemical cell. In some instances, the top plate has a raised press platform oriented within the outer circumference of the top plate and the bottom plate has a corresponding recessed section to fluidly isolate the battery cell within the housing.

### CROSS-REFERENCE TO RELATED APPLICATION

This application is related to and claims priority under 35 U.S.C. § 119(e) from U.S. Patent Application No. 63/662,832 filed Jun. 21, 2024 titled “Sealable Fixture for High-Pressure Compression of Solid-State Electrochemical Cells or Components Thereof,” the entire contents of which is incorporated herein by reference for all purposes.

### TECHNICAL FIELD

Various embodiments described herein relate to the field of solid-electrolyte battery cells containing primary and/or secondary electrochemical cells, solid-electrolyte also referred to as separators, electrodes, and electrode materials, and the corresponding methods of making and using the same.

### BACKGROUND AND INTRODUCTION

The evolution of hybrid and electric automobiles and other battery powered vehicles, and more generally battery-powered devices, is driving needs for battery technologies with improved reliability, capacity, thermal characteristics, lifetime, and recharge performance, among other things. Currently, although lithium-based and other solid-state battery technologies offer potential improvements in safety, packaging efficiency, and enable new high-energy chemistries as compared to other types of batteries, improvements in solid-state battery technologies are needed, including advances in high volume production and cost reductions to the same.

When replacing the liquid electrolyte with a solid electrolyte, a new problem presents itself. This problem comes in the form of ensuring optimal contact between various battery components (e.g., contact between solid electrolyte layers and corresponding contact between electrode layers). When optimal contact between these battery components is not obtained, the solid-state battery may exhibit sub-optimal electrochemical performance, such as a shorter cycle life and lower power output. The act of applying high pressures to compress the components together—known as densifying or laminating—has been shown to be effective to obtain optimal contact between layers. However, most traditional lamination techniques may result in deformation and/or warping of the layers of the solid-state battery, particularly in solid state batteries with a relatively larger footprint such as higher power batteries for transportation.

It is with these observations in mind, among others, that various aspects of the present disclosure were conceived.

### SUMMARY

One aspect of the present disclosure relates to a housing for applying force to an electrochemical cell. The housing may include a bottom plate and a top plate mating with the bottom plate, wherein a layer of the electrochemical cell is sealed between the bottom plate and the top plate for pressurizing through an isostatic press applying a uniaxial pressing force across the layer of the electrochemical cell.

Another aspect of the present disclosure relates to a method for applying force to layers of a battery cell. The method includes loading an electrochemical cell in a bottom plate of a housing, mating the bottom plate with a top plate to encase the electrochemical cell within the housing between the top plate and the bottom plate, and pressurizing, through an isostatic press, the electrochemical cell, the isostatic press applying a uniaxial pressing force across a layer of the electrochemical cell.

### BRIEF DESCRIPTION OF THE DRAWINGS

FIG. 1 is a diagram illustrating a housing for applying force to an electrochemical cell using an isostatic press, according to some embodiments.

FIG. 2A is a diagram illustrating the construction of the housing for applying force to an electrochemical cell using an isostatic press, according to some embodiments.

FIG. 2B is a diagram illustrating a cross-section side view of the housing located within an isostatic press to apply uniaxial pressure to the electrochemical cell, according to some embodiments.

FIG. 2C is a diagram illustrating a cross-section side view of the housing located within a pouch and placed within an isostatic press to apply uniaxial pressure to the electrochemical cell, according to some embodiments.

FIG. 3 is a method for utilizing a housing for applying force to an electrochemical cell using an isostatic press, according to some embodiments.

### DETAILED DESCRIPTION

Lithium-based rechargeable batteries are popular to power many forms of modern electronics and have the capability to serve as the power source for hybrid and fully electric vehicles. Traditional electrode manufacturing for lithium-based rechargeable batteries can be a time-consuming and inefficient process, however. To manufacture a graphite anode, for example, a graphite slurry is produced that includes graphite components, binders, and some kind of solvent that is then applied to a metal foil, such as a copper foil, by a process of extrusion, rolling, or tape-casting, depending on selected process and solvents used. After application, the coated graphite mixture is dried by evaporation of solvents, such as by running the coated slurry through an oven or other drying machine. Cathode construction may occur in a similar manner with an aluminum foil used.

In an alternate approach, the electrode may be comprised of solid-state components layered in an electrode configuration. In particular, an electrode laminate for a battery may include a solid-state separator layer in place of a traditional separator layer/liquid electrolyte used in conventional liquid electrolyte battery architectures. Typical solid-state separator layers use some type of polyethylene material with a ceramic coating to separate the anode from the cathode and prevent shorts within the battery. The stack electrode may also include the solid-state electrolyte separator layer to allow the flow of electrons between the cathode and anode through the layer and also insulate the anode and cathode from direct contact, without the use of a liquid electrolyte. Regardless, each of the multiple steps to produce the battery stack may introduce inefficiencies or opportunities for flaws to in the battery design, resulting in shorter battery life or potential for a short within the battery itself. For example, one or more layers of the battery stack may be quite delicate and may tear or break if handled roughly during construction of the electrode stack. These tears or breakages within the layers of the electrode stack can lead to an inefficient battery. As such, tremendous care is typically required in the manufacturing and handling of battery electrodes to prevent damaging one or more layers of the electrode stack.

The term “battery” in the art and herein can be used in various ways and may refer to an individual cell having an anode and cathode separated by an electrolyte, solid or liquid, as well as a collection of such cells connected in various arrangements. A battery or battery cell is a form of electrochemical device. Batteries generally comprise repeating units of sources of a countercharge and electrode layers separated by an ionically conductive barrier, often a liquid or polymer membrane saturated with an electrolyte. These layers are made to be thin so multiple units can occupy the volume of a battery cell, increasing the available power of the battery cell with each stacked unit. Although many examples are discussed herein as applicable to a battery cell, it should be appreciated that the systems and methods described may apply to many different types of batteries ranging from an individual cell to batteries involving different possible interconnections of cells, such as cells coupled in parallel, series, and parallel and series. For example, the systems and methods discussed herein may apply to a battery pack comprising numerous cells arranged to provide a defined pack voltage, output current, and/or capacity. Moreover, the implementations discussed herein may apply to different types of electrochemical devices such as various different types of batteries and solid-state batteries of various possible chemistries, to name a few. The various implementations discussed herein may also apply to different structural battery cell arrangements such as button or “coin” type batteries, cylindrical battery cells, pouch battery cells, and prismatic battery cells.

Aspects of the present disclosure involve systems and methods of producing an electrode, which may be for a battery that includes a solid-electrolyte separator layer. Further, the present disclosure involves systems and methods for reducing or preventing damage to one or more of the layers within the electrode stack, which may include one or more anode layers, one or more cathode layers, one or more solid-electrolyte separator layers, etc., during the manufacturing process. For example, a layer of lithium material may be used as a conductive layer of the stack. However, such a lithium layer may be very fragile and susceptible to tearing, breaking, or other damage during the manufacturing process (e.g., the layering of materials to create the electrode stack). To address the observed instabilities of solid-state electrode manufacturing, aspects of the present disclosure involve providing uniform lamination and/or densification, provide ease of manufacturing and repeatability, among other things, when laminating a solid-state battery, aspects of the present disclosure include placing a fully assembled electrochemical cell, which may also be pouched, (also referred to herein as a battery) in a housing device and applying an isostatic pressure to the battery within that housing. The isostatic pressure applied to the battery may densify the layers of the electrochemical cell as well as laminate the layers at boundaries between the layers for improved cycling characteristics while reducing the deformation typically seen during other lamination or pressing techniques. In another iteration, multilayer stacks (e.g., layers of electrodes and solid electrolyte) may be used in place of a fully assembled electrochemical cell and pressed in a similar manner to laminate the stack layers together and/or densify the materials of the various layers. The laminated/densified stack may then be used to further assemble a battery. In one aspect of the present disclosure, an isostatic press may be used to apply a uniform pressure to the layered cell structure as opposed to or in addition to any densification that may take place prior to the isostatic press.

In general, the implementations discussed herein may be used with and/or include any type of isostatic pressing device. In one particular implementation, a warm isostatic press (WIP) may be utilized. Although discussed herein as including a WIP, it should be appreciated that the devices, methods, systems, and the like discussed may apply to any isostatic press. Thus, although the term “warm, isostatic press” and “WIP” may be used herein, other isostatic presses are contemplated for use with the disclosed embodiments.

An isostatic press, including a WIP, generally involves application of a uniform pressure onto every exposed surface of an object in the pressurized fluid in the WIP. However, although the use of WIP to pressurize a battery to laminate or densify the layers of the battery, or do the same to components of the battery as introduced above, has some benefits including uniform application of pressure, many challenges may arise. For example, the WIP may require additional cell preparation and cleanup, including the potential for batteries to be individually packaged, which adds to cell preparation and post-press processing time while also increasing consumable cost. If a battery cell stack or discrete portions of a battery are placed directly in the WIP, without more, and subjected to the pressure of the WIP, it may cause mechanical damage to one or more layers of the stack, resulting in shorter battery life or potential for a short within the battery itself. For example, the WIP applies pressure equally to all surfaces. However, the edges and sides of the cell stack, without protection, may be susceptible to damage at high pressures. Similarly, without protection, pressure applied to the tab and/or weld areas of the battery may also be more susceptible to damage due to high pressure.

Aspects of the present disclosure involve systems, devices, and methods of producing a solid-state battery cell using an isostatic press to apply a substantially uniaxial load on the flat surfaces of the cell, while limiting or eliminating the pressure applied to the sides and outside of the cell to minimize or reduce damage to those portions of the cell. In some arrangements, the substantially uniaxial force is perpendicular to the large planar surface(s) of the cell or portion of the cell being laminated or densified. In one implementation, a cell housing, configured for the size and thickness of cells to be processed or some other component of the cell to be processed, is provided. The housing may have a shape and depth such that individual battery cells or some portion thereof may lie within the housing. For example, although discussed herein as a rectangular housing, other shapes of the housing are contemplated, such as circular housing for circular electrochemical cells. In general, the aspects of the housing discussed herein may apply to any type of an isostatic press housing to accommodate any type of electrochemical cell. Also, the housing may include features, described in greater detail below, to prevent damage to the electrochemical cell from the isostatic pressure applied to the layers of the cell.

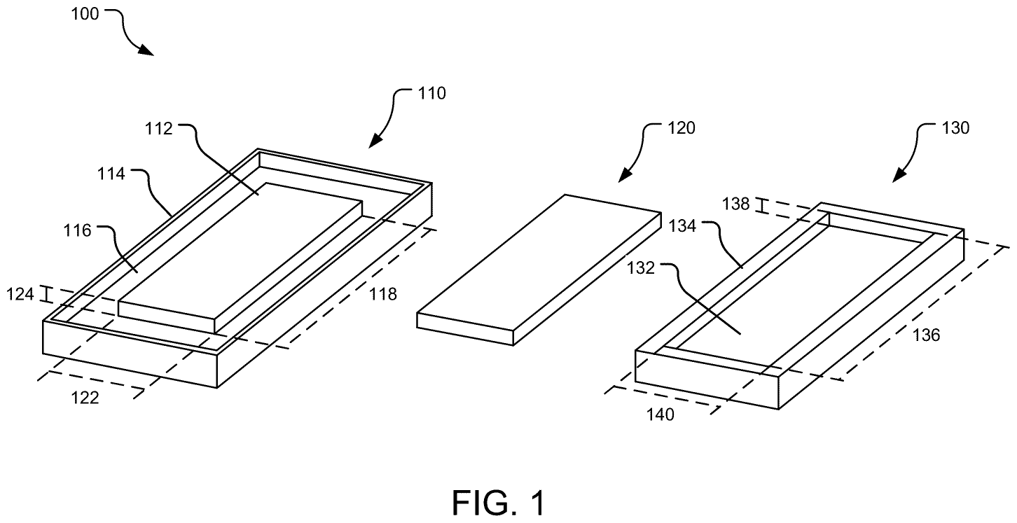

FIG. 1 shows one embodiment of a housing 100 that may be utilized in an isostatic press for processing an electrochemical cell 120. In the example illustrated, the housing device 100 may include a top (or first) plate 110 and a bottom (or second) plate 130, between which an electrochemical cell 120 (represented as a rectangular structure in FIG. 1, noting that discrete layers of the cell and other features of the cell are not illustrated) may be located for isostatic pressing of the electrochemical cell 120. The use of the terms top and bottom are from the perspective of the figures, and should not be construed as limiting noting that depending on orientation, use and processing within the WIP, the top may be the bottom, or a side, etc. Thus, the use of the terms top and bottom is simply for ease of discussion herein. In some instances, the top plate 110 has a raised press platform 112 oriented within the outer circumference of the top plate. The raised press platform is offset from a floor 116 of the top plate. This platform 112 has a length, width, and height which may all be sized in any given embodiment to accommodate the format, size, shape, etc. of any electrochemical cell or multilayer stack to be processed in the housing. For example, the raised press platform 112 may have a width and a length corresponding to the width and the length of the electrochemical cell 120. In other examples, the raised press platform 112 has a length and/or a width slightly larger than the corresponding length or width of the electrochemical call 120. The raised press platform 112 may also be separated from an edge of the top plate 110 such that at least one valley or indentation may be located between the raised press platform and the edge of the top plate 110 on at least one side.

In many instances, the cell 120 is generally rectangular in shape and may be with or without conductive tabs (shown here without conductive tabs) extending from opposing ends of the cell. The cell 120 may include a plurality of stacked layers of materials within the cell, namely electrode layers (at least an anode layer and at least one a cathode layer), and at least one separator layer (which is a solid electrolyte layer). In some instances, a first conductive tab extending from one end of the cell 120 is connected with the anode layer (or anode layers) of the electrochemical cell inside, typically at a current collector or current collectors, and a second conductive tab, which may be at the other end of the cell or adjacent the first tab, is connected with the cathode (or cathodes) of the electrochemical cell, also at a current collector or collectors. Battery cells 120 may be of varying configurations including different shapes, such as the shape of a rectangle or square in possible examples. Further, the battery cell 120 may include a pouch surrounding and encapsulating the electrochemical stacked layers within the pouch. In such examples, the pouch cell 120 includes a sealed rectangular periphery around the enclosed battery cell, from which the tabs extend. The sealed periphery of the pouch is located where the outer flexible pouch material layers extend beyond the encapsulated area of the layered cell structure, such as electrochemical cell, within the bonded and sealed layered structure of the pouch. Regardless, the cell 120 has a first planar surface and a second planar surface opposite the first planar surface. For ease of reference, a battery cell with tabs, as well as discrete anode, cathode or other discrete layers of a cell, are illustrated and represented here as a rectangle. As both the surfaces are planar, the distributed force from an isostatic press as explained above may be applied to one or both surfaces to laminate the layers of the cell together and densify the particles forming the various layers or any discrete anode, cathode, etc., being processed with the housing.

In some examples, the stack of layers of material of the internal cell structure of the cell 120 may be laminated by the isostatic press by locating the cell within the housing device 100 and placing the housing device, with the cell 120 in the housing device, into an isostatic press. As noted, the isostatic process and devices described herein may be used to laminate a cell stack after or prior to pouching, densify discrete cell components such as an anode or cathode, or combinations of the same, among other uses where lamination and/or densification of an electrochemical structure would be beneficial. In some instances, the isostatic press used to laminate the cell 120 may be filled with a fluid, such as water or oil, that is pressurized to cause the fluid within the WIP to apply a pressing force to the exposed surfaces of the cell structure within the WIP. The pressing force applied to the housed cell structure may be between 20 k-60 k pounds per square inch, in some embodiments. In some instances, the fluid may be warmed up to 90 degrees Celsius, such that the press may be considered a warm isostatic press or WIP. The combination of warmth and pressure may be further beneficial for lamination of the layers. As noted, the system may also densify the layers, or further densify the layers if the cell structure was densified prior to processing in the isostatic press.

As noted above, the housing 100 for use in isostatic pressing of an electrochemical cell 112 may include a top plate 110 including a raised press platform 112 offset inwardly from a peripheral sidewall (or raised edge) of the top plate. The raised press platform 112 may be rectangular in shape such that the platform includes a length 118. In one example, the length 118 of the platform 112, which may also be referred to as a central platform noting that it need not be centered within the opening of the top plate 110, may be approximately equal to the length of one or more of a coated active area of an electrode contained in the electrochemical cell such as having the same length as a cathode layer, anode layer, or separator layer. In other words, the length 118 of the central platform 112 may be similar to a length of a layer of the cell 120 placed within the housing atop the raised press platform 112. In still further examples, the length 118 of the central platform 112 may be greater than one or more layers contained in the electrochemical cell 120, such as having a length greater than that of a cathode layer, anode layer, or separator layer. In some instances, the length 118 of the raised, central platform 112 may even be greater than the length of any pouching material that may extend beyond the length of the layers contained in the electrochemical cell. The length 118 of the central platform 112 may also be longer than some layers but shorter than others, such as being longer than the cathode layer but shorter than the anode layer or a separator layer.

Similarly, a width 122 of the central platform 112 may be equal to the width of one or more layers contained in the electrochemical cell 120 housed within the housing 100 such as having the same width as a cathode layer, anode layer, or separator layer. The width 122 of the central platform 112 may be greater than one or more layers contained in the electrochemical cell 120 such as having a width greater than that of a cathode layer, anode layer, or separator layer. The width 122 of the central platform 112 may even be greater than the width of any pouching material that may extend beyond the width of the layers contained in the electrochemical cell 120. The width of the central platform 112 may also be greater than some layers but less than others such as having a width greater than the cathode layer but less than that of the anode layer of the housed electrochemical cell 120.

In one implementation, the length 118 and width 122 of the central platform 112 may be the same as a corresponding length and width of a cathode layer of the electrochemical cell 120. Designing the dimensions of the central platform 112 to correspond to the cathode layer of the cell 120 may be utilized in cell designs in which the dimensions of the anode layer are larger than the cathode layer to prevent contact between the layers during pressing and causing a short within the electrochemical cell. In another implementation, the length 118 and width 122 of the central platform 112 may correspond up to and including an area of an anode layer of the electrochemical cell 102. This particular implementation may be utilized in electrochemical cell designs in which the anode layer is larger, in both or either a width and a length dimension, to the cathode layer.

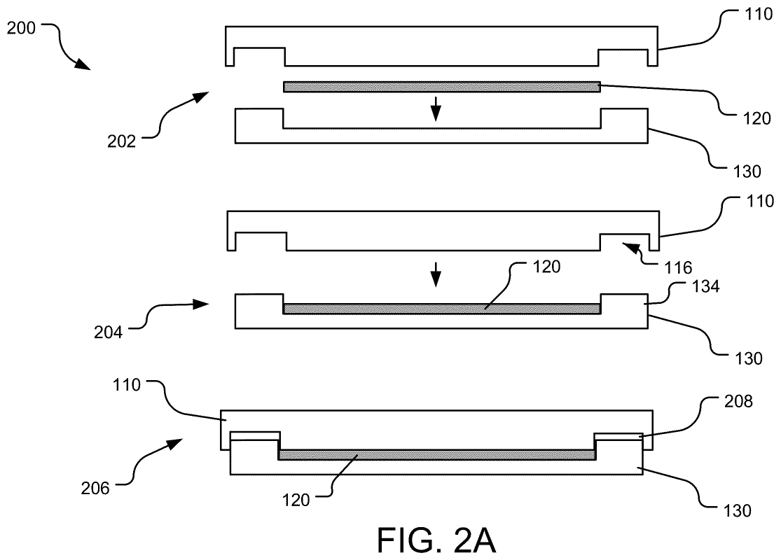

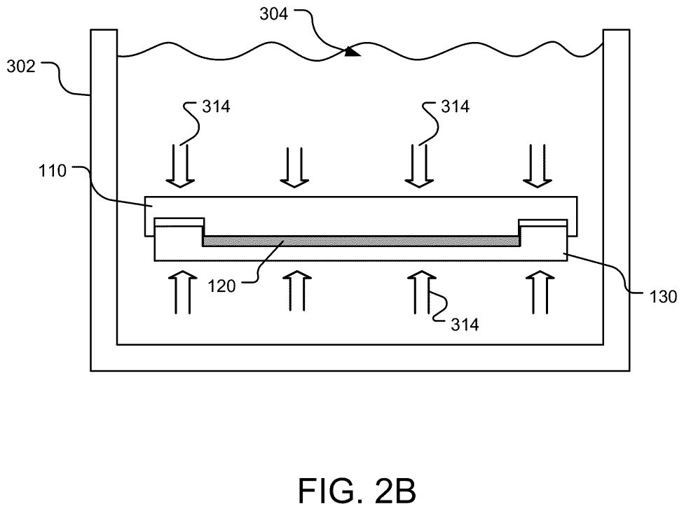

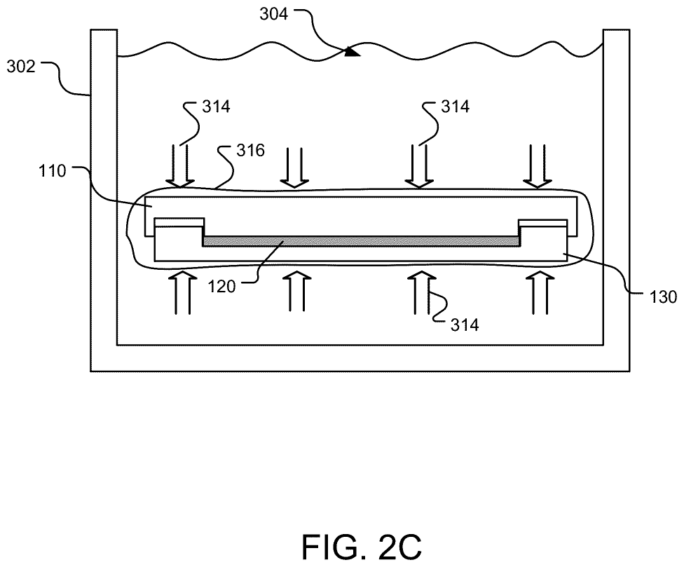

The height 124 of the central platform 112, above the floor, may be greater than zero. In some cases, the height of the central platform is greater than 0 um but less than the height of the electrochemical cell. As illustrated in FIG. 2, discussed in more detail below, the height of the press platform is sufficient to densify and laminate the battery cell (or component thereof) without the rectangular border wall 134 of the bottom plate 130 that fits in the rectangular space between the peripheral wall 114 and the press platform 114 bottoming out against the floor 116 of the top plate before sufficient densification and/or lamination occurs.

In some instances, the top plate 110 has a raised edge 114, shown as a rectangular sidewall, around the outer perimeter of the plate. A rectangular channel is defined between the raised press platform and the sidewall that receives a rectangular raised area 134, or sidewall, of the bottom plate. This raised edge 114 has a length, width, and height which may each be configured to accommodate the format as well as the length, width and height of any electrochemical cell 120 or multilayer stack to be processed by in a WIP using the housing. In some implementations, the length of the raised edge 114 may be the same as the length of the top plate 110, with the width of the raised edge 114 being greater than 0 um and the height of the raised edge 114 being greater than 0 um. In some instances, the height of the raised edge 114 may be greater than the height of the bottom plate of the housing device 130, discussed in more detail below.

The top plate 110 also has a floor 116 between the inside of the raised edge 114 and the outside edge of the raised central platform 112. In general, the central platform 112 and the raised edge 114 extend substantially perpendicularly from the floor 116 of the top plate 110. A space, in the example shown as rectangular, is defined between the platform 112 and the sidewall 114 surrounding the platform 112.

In addition to the top plate 110 and as also shown in FIG. 1, the housing device 100 may include a bottom plate 130 with a recessed platform 132 in which the cell is positioned prior to processing and while the top plate is not engaged with the bottom plate so as to enclose the cell prior to insertion in the WIP. The recessed platform 132 may include a length 136, a width 140, and a depth 138. In one example, the length 136 of the recessed platform 132 should be greater than the length 122 of the raised press platform 112 located on the top plate 110. Alternatively, the length 136 of the recessed platform 132 should be greater than or equal to the length of the longest section of the electrochemical cell 120 or pouching material used to contain said electrochemical cell and able to receive the cell and press platform.

The width 140 of the recessed platform 132 may be greater than the width of the raised press platform 112 located on the top plate 110. Alternatively, the width 140 of the recessed platform 132 may be greater than or equal to the width of the longest section of the electrochemical cell 120 or pouching material used to contain said electrochemical cell.

As mentioned above, some electrochemical cells 120 may include one or more tabs extending from the cell. In some instances, the dimensions (the width 140 and/or the length 136 of the recessed platform 132 may be large enough to accommodate the one or more tabs extending from the electrochemical cell 120. In general, the dimensions of the recessed platform 132 are such to accommodate the electrochemical cell 120, including instances in which the electrochemical cell 120 is pouched and/or includes one or more connection tabs extending from the cell.

In some instances, the recessed platform 132 may include one or more features to ensure that the electrochemical cell 120 is located directly or substantially beneath the central platform 112 when the top plate 110 and the bottom plate 130 are mated. For example, the recessed platform 132 may include an indention in the bottom of the platform to accommodate one or more layers of the cell 120 to centrally locate the cell within the recessed platform 132. In another example, a controllable machine may locate the electrochemical cell 120 within the recessed platform 132 in a centrally located position. In this implementation, the controllable machine may locate the entire electrochemical cell 120, either pouched or unpouched, or may locate one or more individual layers of the cell centrally located within the recessed platform 132. The controllable machine may also place the top plate 110 onto the bottom plate 130 after the stacking of the layers within the recessed platform 132.

The depth 138 of the recessed platform 132 may be greater than zero. In some cases, the depth 138 of the recessed platform 132 may be less than the combined height of the raised press platform 132 and the height of an electrochemical cell 120. In some iterations, it may be preferred that the depth of the recessed platform is 1% to 10% less than the combined height of the raised press platform 132 and the height of an electrochemical cell 120.

As noted above, the electrochemical cell 120 shown in FIG. 1 may contain one or more cathode layers, anode layers, and/or separator layers. In some cases, each layer may have a unique length, height, and width. In other cases, at last one of the separator layer, cathode layer, or anode layer has the same length, height, and width. In some scenarios, the electrochemical cell 120 shown in FIG. 1 may be replaced with one or more battery components ranging from a single layer or multilayer stacks containing one or more separator layers, cathode layers, anode layers, and/or combination. For example, the electrochemical cell 120 within the housing 100 may include an anode layer that is densified through the use of the WIP prior to including in the electrochemical stack. In general, any layer of material may be included in the housing 100 for application of an isometric pressure on the material.

The components of the housing 100 discussed above may be stacked to generate the housing, within which the electrochemical cell 120 is located. For example, FIG. 2A shows an orientation of the components of the housing 100 to load an electrochemical cell 120 into the housing device 100. The components of the housing 100 are the same or similar to those discussed above such that the numerical indicators are similar between the components of the Figures. In particular, the housing device 100 of FIG. 2A includes a top plate 110 and a bottom plate 130, between which an electrochemical cell 120 may be located. Thus, FIG. 2 illustrates a representative cross-section of the housing device 100 (100) and a process through which the electrochemical cell 120 is positioned between the top plate 110 and the bottom plate 130, and then processed within a WIP.

As illustrated, the electrochemical cell 120 is placed against or within the recessed platform 132 of the bottom plate 130. The top plate 110 is then pressed against the electrochemical cell 120. In some cases, there may be a gap 208 between the top of the raised edge 134 on the bottom plate 130, and the floor 116 of the top plate 110. This gap 208 may have a height between 1% to 10% the height of the electrochemical cell 120. However, in some instances, such a gap 208 may introduce a pathway for the fluid of the isostatic press to contact the electrochemical cell 120 within the housing. Thus, the gap 208 may be such that the electrochemical cell 120 is completely sealed within the housing 100. For example, the top plate 110 and/or the bottom plate 130 may be constructed of a material with enough flexibility to allow for the pressing force of the isostatic press to laminate and/or densify the layers of the electrochemical cell 120 with no gap 208 between the top plate and the bottom plate.

When the top plate 110 and the bottom plate 130 are brought together, the portion around the recessed platform 132 (i.e., the sidewall 134 around the recess of the bottom plate 130) may be inserted into the gap 116 between the press platform 112 and the raised edge or sidewall 114 of the top plate 110 to protect the cell supported in the housing from pressurized fluid that will be pressing the upper plate and the lower plate, and translating the press platform and recessed platform to press, through the engagement of the flat surfaces of the press platform and the recessed platform on the respective flat faces of the cell captured therebetween. The fit between the recessed platform sidewall in the gap of the upper platform may at least partially seal the area where the cell is captured between the top plate and the bottom plate within the housing 100.

Once mated, the housing with the electrochemical cell 120 between the top plate 110 and the bottom plate 130 may be placed within an isostatic pressing device. FIG. 2B is an example diagram illustrating a cross-section side view of the housing located within an isostatic press 302 to apply uniaxial pressure to the electrochemical cell. As noted above, the isostatic press 302 generally involves application of a uniform pressure 314 onto every exposed surface of an object in the pressurized fluid 304 in the press. In one instance, the isostatic press 302 may be used to pressurize a battery to laminate or densify the layers of the battery, or do the same to components of the battery. In the example of the present disclosure, the assembled housing with the electrochemical cell 120 within the housing may be located within the fluid 304 of the isostatic press 302. The fluid 304 is then pressurized to isostatically press 314 along the exposed surfaces of the housing. More particularly, a pressing force 314 is applied evenly across the outer surface of the top plate 110 and the outer surface of the bottom plate 130 of the housing, pressing the two plates towards each other. The pressing force 314 is then transmitted through the plates 110, 130 to the electrochemical cell 120 located within the housing to laminate and/or densify the layers of the electrochemical cell. In addition, the housing may be at least partially sealed such that the fluid 304 of the isostatic press 302 does not enter the housing and contact the electrochemical cell 120 located therein. In another implementation illustrated in FIG. 2C, the assembled housing 100 with the electrochemical cell 120 may be placed inside a fluid-proof pouch 316 prior to placement within the isostatic press 302. The pouch 316 may prevent the fluid 304 may contacting the housing 100 and/or the electrochemical cell 120 in instances of the housing that may not be fluid-proof.

Returning to FIG. 2A, with the bottom image 206 illustrates the arrangement of the housing as it would be positioned in the isostatic press 302 to process the electrochemical cell 120 captured therein between the press platform of the top plate 110 and the recessed platform of the bottom plate 130. To aid in sealing the top plate 110 to the bottom plate 130, one or more gaskets may be placed between the components, such as in gap 208. For example, a gasket may be located between floor 116 of the top plate and raised edge 134 of the bottom plate. This gasket may be made of a polymer, an inorganic composite, lead, magnesium, or combination thereof. In general, the gasket is compatible with the medium or fluid used in the isostatic press. For example, a gasket compatible with an oil-based fluid may be utilized for oil-based isostatic presses while gaskets compatible with a water-based fluid may be utilized for water-based isostatic presses. The dimensions of this gasket are not limited, but may touch floor 116. The gasket may be as wide as raised edge 134 or smaller. In some cases, the gasket may be as wide as floor 116 or smaller. Other gaskets may be used to further seal the top plate 110 to the bottom plate 130. As mentioned above, the fluid used in the WIP may damage the electrochemical cell 120 located within the housing 100 during the pressing of the cell. Thus, the housing 100, and one or more gaskets oriented within the housing, may prevent or reduce the amount of fluid contacting the electrochemical cell 120.

Further, the dimensions of the components of the housing 100 may reduce spreading of the layers of the electrochemical cell 120 that may occur during pressing. In particular, the mating of the top plate 110 with the bottom plate 120 may create a container for the electrochemical cell. For example, the electrochemical cell 120 may be placed between the central platform 112 of the top layer 110 and the recessed platform 132 of the bottom layer 130. Further, walls of the recessed platform 132 of the bottom layer may correspond to the dimensions of the electrochemical cell 120 such that, when the isostatic pressure is applied to the cell, the layers or layer of the electrochemical cell 120 may be substantially retained within the recessed platform to retain the cell shape during pressing. In other words, the walls of the recessed platform 132 (and the shape and dimensions of the central platform 112 of the top plate 110) may prevent or resist the spreading of the layers of the electrochemical cell 120 when the cell layers are pressed.

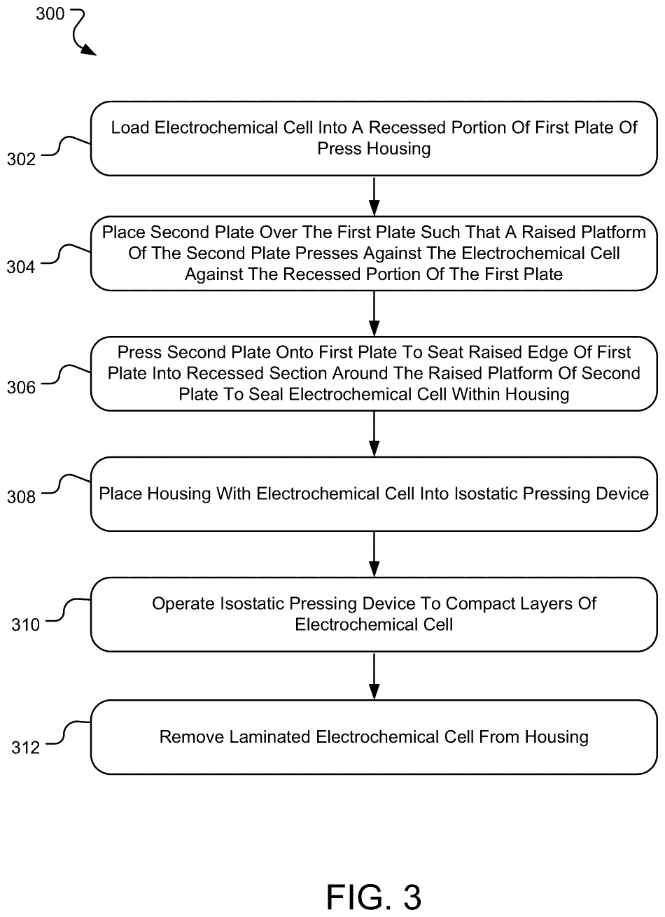

FIG. 3 is a method for utilizing the housing 100 discussed above to apply a pressing force to an electrochemical cell using an isostatic press. As noted above, the pressing force may be applied to the electrochemical cell 120 to densify and/or laminate one or more layers of the electrochemical cell. At operation 302, the electrochemical cell 202 may be loaded into a recessed portion of a first plate 130 of the housing 100. As described above, the electrochemical cell 202 may include one or more layers of a cell device. The recessed portion of the first plate 130 may be shaped to accommodate the electrochemical cell. For example, a length, a width, and/or a depth of the recessed portion of the first plate 130 may be larger than a corresponding length, a width, and/or a depth of the electrochemical cell 202 such that the cell may lie within the recessed portion. At operation 304, a second plate 110 of the housing 100 may be located over the first plate 130 such that a raised press platform of the second plate presses against the electrochemical cell, thereby pressing the electrochemical cell against the recessed portion of the first plate 130. As also described above, a length and/or a width of the raised press platform may be the same size or larger than a corresponding length and/or width of the electrochemical cell 120. Through the placement of the second plate 110 in this manner, the electrochemical cell 120 may be entirely located between the recessed portion of the first plate 130 and the raised press platform of the second plate 110.

In operation 306 of method 300, the second plate 110 and the first plate 130 may be pressed towards the other to seat a raised edge of first plate into a recessed section of the second plate to seal the electrochemical cell within the housing 100. In particular, the second plate 110 may include a recessed portion around the circumference of the raised press platform of the second plate. The first plate 130 may include a corresponding raised edge around the circumference of the recessed portion of the first plate. When mated, the raised edge of the first plate 130 may fit into the recessed portion of the second plate 110. In some implementations, the raised edge of the first plate 130 and the recessed portion of the second plate 110 may be pressed fit such that a liquid-tight seal is created around the electrochemical cell 120 when the first plate and the second plate are seated. In other words, when the electrochemical cell 120 is housed within the housing 100 between the raised press platform of the second plate 110 and the recessed portion of the first plate 130 and the first plate and the second plate are press fit, the electrochemical cell is liquid sealed within the housing.

In operation 308, the housing 100 with the electrochemical cell 120 housed inside may be placed inside an isostatic press device. As discussed above, an isostatic press generally involves application of a uniform pressure onto every surface of an object within the press through a pressurized fluid. The pressurized fluid of the isostatic press primarily applies opposing forces on the planar surfaces of the housing 100 and the electrochemical cell 120 within the housing, thereby laminating the layers of the stack and/or densifying the material of the stack layers. Pressing the cell stack with the uniform opposing pressure of an isostatic press device may allow for a more consistent lamination and may help avoid cracking tied to non-uniform force. Thus, in operation 310 the isostatic press device may be operated to compact one or more layers of the electrochemical cell 120. In some instances, the isostatic device is filled with a fluid, such as water or oil, that is pressurized to apply a pressing force to the submerged cell pouch between 20 k-80 k pounds per square inch, in some embodiments. In addition, the fluid may be warmed up to 100 degrees Celsius or more. The combination of warmth and pressure may cause lamination of the layers, with some densification of the layers due to the pressure. Also, in some instances, the electrochemical cell may be inserted into a fluid-proof pouch to prevent the water or oil from contacting the cell.

Following the pressing, the electrochemical cell 120 may be removed from the housing 100 in operation 312. Following the removal of the electrochemical cell 120, the housing 100 may be reused to press another electrochemical cell through the operations of the method 300 of FIG. 3. In this manner, a reuseable housing for isostatic pressing of electrochemical cells may be utilized for construction of various types of electrochemical cells.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

What is claimed is:

1. A housing for applying force to an electrochemical cell, the apparatus comprising:
a bottom plate; and
a top plate mating with the bottom plate, wherein a layer of the electrochemical cell is sealed between the bottom plate and the top plate for pressurizing by an isostatic press applying a uniaxial pressing force across the bottom plate and the top plate that is translated to the layer of the electrochemical cell through the bottom plate and the top plate.

2. The housing of claim 1 wherein the bottom plate comprises:
a raised lip around the circumference of the bottom plate; and
a recessed platform defined by the raised lip.

3. The housing of claim 2 wherein the dimensions of the recessed platform comprise a length greater than or equal to a length of the layer of the electrochemical cell and a width greater than or equal to a width of the electrochemical cell.

4. The housing of claim 2 wherein the top plate comprises:
a raised central platform;
a raised lip around the circumference of the top plate; and
a recess circumventing the raised central platform between the raised central platform and the raised lip.

5. The housing of claim 4 wherein the dimensions of the raised central platform comprise a length equal to a length of the layer of the electrochemical cell or a width equal to a width of the layer of the electrochemical cell.

6. The housing of claim 4 wherein the dimensions of the recessed platform comprise a length less then the length of the raised central platform or a width less than the width of the raised central platform.

7. The housing of claim 4 wherein the top plate further comprises:
a floor surface between the raised central platform and the raised lip of the top plate.

8. The housing of claim 7 further comprising:
a gap between the raised lip around the circumference of the bottom plate and the floor surface when the top plate is mated with the bottom plate.

9. The housing of claim 2 wherein the electrochemical cell is captured in a recessed area of the recess platform and oriented between the raised central platform and the recessed platform when the top plate is mated with the bottom plate.

10. The housing of claim 9 further comprising:
a gasket oriented between the raised lip around the circumference of the bottom plate and the floor surface when the top plate is mated with the bottom plate to seal the electrochemical cell within the housing.

11. A method for applying force to layers of a battery cell, the method comprising:
loading an electrochemical cell in a bottom plate of a housing;
mating the bottom plate with a top plate to encase the electrochemical cell within the housing between the top plate and the bottom plate; and
pressurizing, through an isostatic press, the electrochemical cell, the isostatic press applying a uniaxial pressing force across the bottom plate and the top plate that is translated to the layer of the electrochemical cell through the bottom plate and the top plate.

12. The method of claim 11 wherein the isostatic press is a warm, isostatic press (WIP) device.

13. The method of claim 11 wherein the bottom plate comprises a raised lip around the circumference of the bottom plate and a recessed platform defined by the raised lip.

14. The method of claim 13 wherein the dimensions of the recessed platform comprise a length greater than or equal to a length of the layer of the electrochemical cell and a width greater than or equal to a width of the electrochemical cell.

15. The method of claim 11 wherein the top plate comprises a raised central platform, a raised lip around the circumference of the top plate, and a recess circumventing the raised central platform between the raised central platform and the raised lip.

16. The method of claim 15 wherein the dimensions of the raised central platform comprise a length equal to a length of the layer of the electrochemical cell or a width equal to a width of the layer of the electrochemical cell.

17. The method of claim 15 wherein the dimensions of the recessed platform comprise a length equal to the length of the raised central platform or a width equal to the width of the raised central platform.

18. The method of claim 15 wherein the top plate further comprises a floor surface between the raised central platform and the raised lip of the top plate.

19. The method of claim 18 wherein mating the bottom plate with the top plate comprises engaging the raised lip around the circumference of the bottom plate with the floor surface.

20. The method of claim 19 further comprising:
locating a gasket between the raised lip around the circumference of the bottom plate and the floor surface when the top plate is mated with the bottom plate to seal the electrochemical cell within the housing.
